(19) United States
(12) Patent Application Publication
(10) Pub. No.: US 2010/0277584 A1
(43) Pub. Date: Nov. 4, 2010

(54) Systems and Methods for Video Surveillance

(76) Inventor: Larry J. Price, South Jordan, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/029,955

(22) Filed: Feb. 12, 2008

Related U.S. Application Data
(60) Provisional application No. 60/942,111, filed on Jun. 5, 2007.
(60) Provisional application No. 60/912,358, filed on Apr. 17, 2007.
(60) Provisional application No. 60/889,411, filed on Feb. 12, 2007.

(51) Int. Cl. H04N 7/18; F16M 11/00; F16M 11/38

(52) U.S. Cl. 348/143; 248/176.3; 248/422; 348/E07.085

(57) ABSTRACT

Surveillance systems and units that are secure, self-contained and readily moveable to satisfy changing surveillance needs are disclosed. The surveillance systems are capable of essentially indefinite operation by way of a battery system and solar panels. The surveillance systems include a unique telescoping mast that elevates a camera or other surveillance device, thereby improving surveillance capabilities while simultaneously deterring theft, vandalism, or other activity to disable the surveillance device. The surveillance units/systems also include an enclosure that contains electronic equipment to serve the surveillance purposes of the surveillance systems. The enclosure may also completely enclose the telescoping mast and any attached surveillance devices during storage or transport, providing an additional measure of security and mobility. The connections between the surveillance device and the electronic equipment may be entirely housed within the telescoping mast, thereby further discouraging tampering and enhancing the security of the surveillance systems.

### CROSS-REFERENCE TO RELATED APPLICATIONS

This application claims the benefit of U.S. Provisional Application No. 60/942,111, filed Jun. 5, 2007, U.S. Provisional Application No. 60/912,358, filed Apr. 17, 2007, and U.S. Provisional Application No. 60/889,411, filed Feb. 12, 2007.

### BACKGROUND OF THE INVENTION

1. Field of the Invention

The present invention relates to video surveillance, and more particularly to systems and methods for use with mobile video surveillance units.

2. Background and Related Art

Video surveillance systems for monitoring job sites and installations are well known, and typically include on-site surveillance equipment, such as video cameras and infrared sensors, positioned at various strategic locations, to capture visual images and other data of a job site or installation. Such surveillance systems generally require a structure on which the camera or other device may be securely mounted at a desirable elevation. In typical situations, conventional surveillance systems require installation of poles along with trenching and pulling cable for cameras and other electronic devices. The cost of installation is typically large, and the time required for typical installations is long, considering the necessary work of mounting cameras and other surveillance equipment, trenching, pulling cables, etc.

Additionally, traditional surveillance systems lack flexibility for use with special events, more temporary activities, smaller job sites and other sites with relatively short surveillance durations, and are not suited for quick removal when no longer needed. A contractor may have several jobsites in various stages of completion, with varying needs for security. Storage yards and shipping docks may be full of valuable freight and supplies at some times while at other times they could be relatively empty. A large sporting event or concert may bring crowds to a location for only a short duration of time. In each of these situations existing surveillance units and systems have proven inadequate to meet security demands.

### BRIEF SUMMARY OF THE INVENTION

Implementations of the present invention provide surveillance systems and units that are secure, self-contained and readily moveable to satisfy changing surveillance needs. The surveillance systems may be capable of operating on a power grid, but are capable of extended, essentially indefinite, operation apart from any dedicated power grid by way of a battery system that is rechargeable by way of attached solar panels. The surveillance systems or units include a unique telescoping mast that elevates the camera(s) or other surveillance device(s), thereby improving surveillance capabilities of the surveillance device(s) while simultaneously deterring theft, vandalism, or other activity to disable the surveillance device(s).

The surveillance units/systems also include an enclosure that contains electronic equipment to serve the surveillance purposes of the units. The enclosure may also completely enclose the telescoping mast and any attached surveillance device(s) during storage or transport, providing a measure of security and mobility previously unattained in existing surveillance systems. The connections between the surveillance device(s) and the electronic equipment may be entirely housed within the telescoping mast, thereby further discouraging tampering and enhancing the security of the surveillance systems.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a side plan view of a surveillance unit in accordance with embodiments of the invention;

FIG. 2 shows a partial top plan view of the embodiment of FIG. 1;

FIG. 3 shows a simplified side plan view of the embodiment of FIG. 1 with a telescoping mast in a fully-retracted position;

FIG. 4 illustrates an perspective view of an alternative embodiment of a surveillance unit;

FIGS. 5-11 show views of a gear box that may be used with a telescoping mast to extend or retract a section of the telescoping mast;

FIG. 12 shows a partially-cutaway view of an alternative gear box;

FIG. 13 illustrates components of an embodiment of a telescoping mast;

FIG. 14 shows a front side view of an alternative embodiment of a surveillance unit having solar panels;

FIG. 15 shows a top view of the embodiment of FIG. 14;

FIG. 16 shows a partially-transparent back side view of an embodiment of a surveillance unit;

FIG. 17 shows a partially-transparent plan side view of an embodiment of a surveillance unit with an extended telescoping mast;

FIGS. 18 and 19 show a trailer that may be used with embodiments of the surveillance unit to make the surveillance unit portable;

FIGS. 20 and 21 show side views of solar panels that may be used with embodiments of the invention;

FIG. 22 shows a plan view of an embodiment of a surveillance unit with an extended solar panel;

FIG. 23 shows a plan view of an embodiment of a surveillance unit with an extended telescoping mast and extended solar panels;

FIG. 24 shows a plan view of an alternative surveillance unit with alternative or rotated solar panels; and

FIG. 25 shows a plan view of the embodiment of FIG. 24 with an extended telescoping mast and extended solar panels.

### DETAILED DESCRIPTION OF THE INVENTION

A description of embodiments of the present invention will now be given with reference to the Figures. Embodiments of the present invention will be best understood by reference to the drawings, wherein like parts are designated by like numerals throughout. The Figures listed above are expressly incorporated as part of this detailed description. It is expected that the present invention may take many other forms and shapes, hence the following disclosure is intended to be illustrative and not limiting, and the scope of the invention should be determined by reference to the appended claims.

Embodiments of the present invention provide surveillance systems and units that are secure, self-contained and readily moveable to satisfy changing surveillance needs. The surveillance systems may be capable of operating on a power grid, but are capable of extended, essentially indefinite, operation apart from any dedicated power grid by way of a battery system that is rechargeable by way of attached solar panels. The surveillance systems or units include a unique telescoping mast that elevates the camera(s) or other surveillance device(s), thereby improving surveillance capabilities of the surveillance device(s) while simultaneously deterring theft, vandalism, or other activity to disable the surveillance device(s).

The surveillance units/systems also include an enclosure that contains electronic equipment to serve the surveillance purposes of the units. The enclosure may also completely enclose the telescoping mast and any attached surveillance device(s) during storage or transport, providing a measure of security and mobility previously unattained in existing surveillance systems. The connections between the surveillance device(s) and the electronic equipment may be entirely housed within the telescoping mast, thereby further discouraging tampering and enhancing the security of the surveillance systems.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

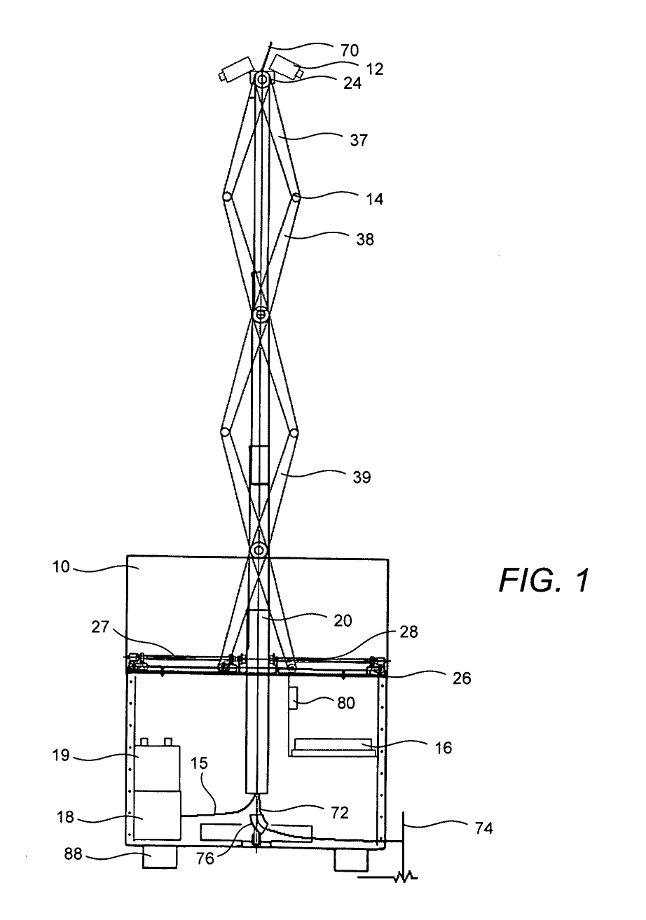

Some embodiments of the present invention, described with reference to FIG. 1, may comprise a base enclosure 10 made of powder-coated steel, stainless steel, or any other suitable and secure materials of construction. The base enclosure 10 may be reinforced with struts, beams, framing, and the like (not shown). The base enclosure 10 may be constructed, so as to be dust-resistant, tamper-resistant and weather-resistant for all reasonable purposes. The base enclosure 10 may comprise a substantially hollow enclosure adapted to accommodate a power supply 18 and electronics equipment 16 for controlling a plurality of surveillance devices 12 mounted on a telescoping mast 20 such as scissor-lift assembly 14 or other suitable mast assembly. The electronics equipment 16 and surveillance devices 12 may be connected to the power supply 18 by hardwiring or quick connect plugs and receptacles. The power supply 18 may be an existing 120V or 220V commercial power source. Batteries 19, generators, solar collectors or other suitable means for providing alternative sources of power (not shown) may also be included in the base enclosure 10 to provide power for the electronics equipment 16 and for the surveillance devices 12.

Some embodiments of the present invention may comprise a distribution box/platform 24, mounted to the upper portion of the telescoping mast 20, for distributing electrical power from the power supply 18 to the various surveillance devices 12 which may be secured to the distribution box/platform 24 with pivotal connectors or pan and tilt devices (not shown). The distribution box/platform 24 may be made of stainless steel or other suitable materials. Power, control and video cables 15 for the surveillance devices 12 may be fed through openings in the telescoping mast 20 from the electronics equipment 16 and power supply 18 to the surveillance device or devices 12. In some embodiments, the various cables 15 may be fed through the hollow interior of the telescoping mast 20 itself, as will be described in more detail below. Feeding the various cables 15 inside the telescoping mast 20 makes it more difficult for criminals and vandals to access and cut the cables 15, increasing the security provided by the surveillance system.

In some embodiments of the present invention, the surveillance devices 12 may comprise many different pieces of equipment, depending on the application requirements. The surveillance equipment may comprise one or a plurality of cameras, for example video cameras, digital cameras, time lapse cameras, fish-eye lenses and/or infrared sensors. Other surveillance equipment may comprise pan and tilt devices, zoom cameras, lights, transmission/receiver devices, motion detectors, light sensors and sound detectors. The surveillance devices 12 and electronics equipment 16 may operate via a wireless network, automatically according to preset instructions, or may be controlled by an operator at the base enclosure or at a remote location. In applications where the system is to be used in a preprogrammed or automatic configuration, the electronics equipment 16 includes the necessary timers and sensors. In applications where the system is to be remotely controlled by an operator located some distance from the surveillance unit, the electronics equipment 16 and the surveillance devices 12 include the appropriate transmitters and receivers as required to enable remote operation.

Some embodiments of the present invention may comprise a combination of digital video and computer networks. Some embodiments may comprise digital cameras with Ethernet connections and support for Internet Protocol (IP) connections to computer networks. Some embodiments may comprise a surveillance unit that may be part of a local network of one or more surveillance units that communicate wirelessly with one or more locations using well-known Internet Transmission Control Protocol/Internet Protocol (TCP/IP) techniques to allow monitoring of the surveillance devices at the home or business of a client or at an organization that provides remote surveillance monitoring by simply typing in the correct URL using any well-known web browser. Some embodiments of the present invention may comprise a portable laptop computer contained in a tray compartment 46 located on one side of the surveillance system base enclosure 10.

In some embodiments of the present invention, where the mobile video surveillance units will be used in an area of the country where lightening is a common occurrence, the surveillance unit may be outfitted with a lightening arrest system comprising a lightening rod 70, an electrical discharge cable 72, and a ground 74. The electrical discharge cable 72 connects the rod 70 with the ground 74. The ground 74 is normally driven into the earth three to six feet to ensure good conductivity with the earth.

In some embodiments of the present invention, a portable surveillance unit may be designed with lift rings and/or forklift slots 88 to allow it to be easily transported from one job site location to another location using equipment such as a backhoe, front-end loader or forklift. In other embodiments the portable surveillance unit may be mounted on heavy-duty wear resistant skids to allow the surveillance unit to be dragged short distances so as not to be in the way of temporary jobsite activities or for redeployment to a more advantageous surveillance location. In still other embodiments, the surveillance unit may be mounted on an axle and wheels with a trailer hitch for transport as a trailer and configured to include appropriate signal, stop and brake lights required for legal travel on public roadways. Some embodiments of the present invention may comprise support jacks on corners or other locations of the surveillance unit which may be lowered into position to stabilize the surveillance unit from the effects of wind and other forces.

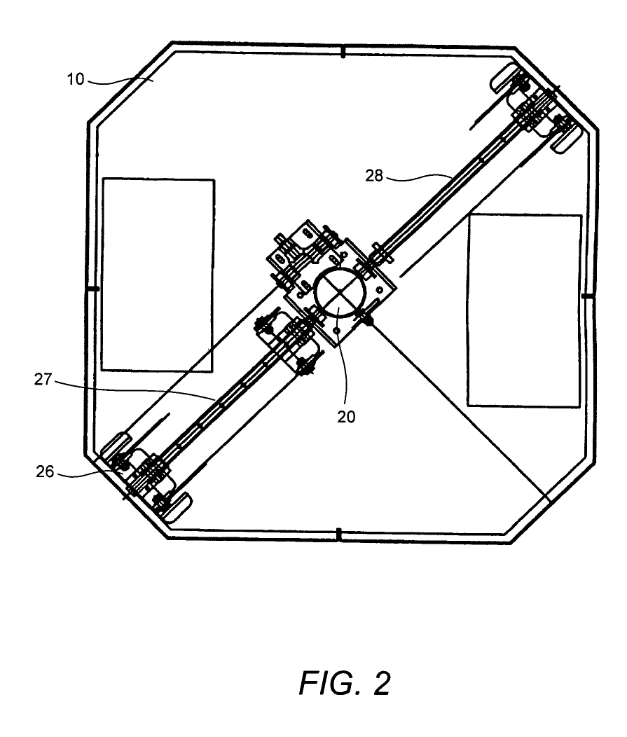

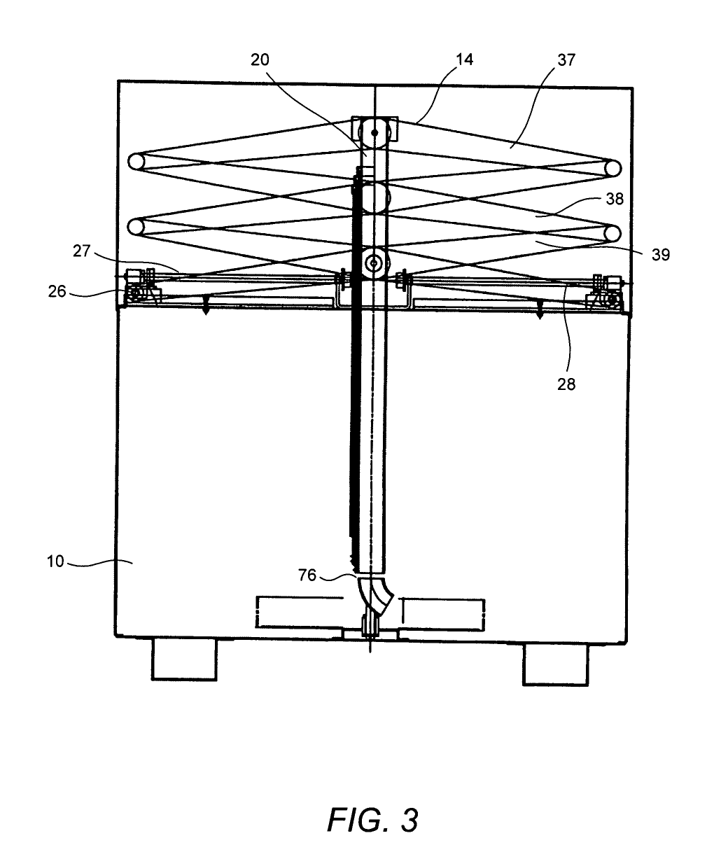

Some embodiments of the present invention, described with reference to FIGS. 1, 2 and 3, may comprise a base enclosure 10 with a scissor-lift assembly 14 and a telescoping mast 20 which is attached to the scissor-lift assembly 14 and may comprise telescoping segments which can be raised and lowered along a predetermined vertical path during operating conditions. The scissor-lift assembly 14 may comprise a motor 26 and a first threaded shaft 27 and second threaded shaft 28 which may be engaged with the motor 26 to rotate in sync during operation and may be conjoined to a plurality of pivotally-moveable support brackets wherein the rotation of the first threaded shaft 27 and second threaded shaft 28 cause the pivotally-moveable support brackets to be raised and lowered respectively depending on the direction of rotation of the threaded shafts. As may be appreciated, using the scissor-lift assembly 14, the surveillance unit may be transported with the telescoping mast 20 in a lowered vertical position that prevents damage. At the surveillance location, the telescoping mast 20 may be raised using the scissor-lift assembly 14 to an elevated operating position that provides improved monitoring and may also prevent tampering with the surveillance device(s) 12 at the top of the telescoping mast 20, as the elevated operating position may be well out of easy reach of would-be criminals and vandals. By way of example and not limitation, the elevated operating position may place the top of the telescoping mast 20 at heights of twelve to twenty feet or more, by varying the number and height of the individual segments of the telescoping mast 20 and the scissor-lift assembly 14.

Some embodiments of the present invent may comprise a scissor-lift assembly 14 with three sections of pivotally-moveable support brackets which are pivotally-moveable relative to one another. The bottom pivotally-moveable support brackets 39 may be mounted to the base enclosure 10 and conjoined with the first threaded shaft 27 and the second threaded shaft 28 on one end so that they move vertically between retracted and expanded conditions upon rotation of the shafts. The top pivotally-moveable support brackets 37 may be mounted to the upper portion of the telescoping mast 20 and linked to the bottom pivotally-moveable support brackets 39 through means of the middle pivotally-moveable support brackets 38 so that all three sections of pivotally-moveable support brackets expand and retract together along with the attached segments of the telescoping mast 20. As will be readily appreciated, the number of pivotally-moveable support brackets may be modified as may the length of each support bracket and segment of the telescoping mast 20 to achieve different deployment heights.

In some embodiments of the present invention the scissor-lift assembly 14 and telescoping mast 20 may be operated by controls housed within the base enclosure 10. In other embodiments the scissor-lift assembly 14 may be operated by a portable laptop computer contained in a tray compartment 16 located on one side of the surveillance system base enclosure 10 or may be pre-programmed to extend and retract according to a pre-set schedule. In still other embodiments, the scissor-lift assembly may be operated by way of remote commands.

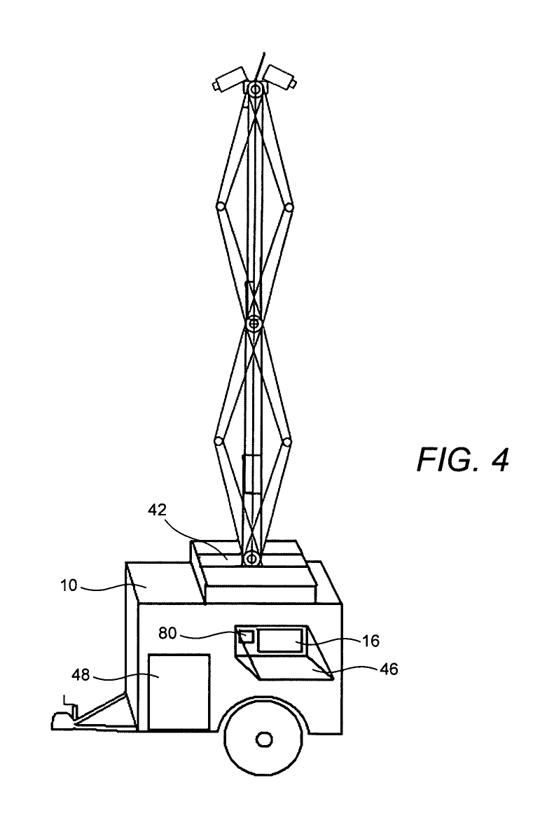

Conditions on a typical jobsite can be harsh and demanding. A portable surveillance system needs to be designed to withstand these job site conditions as well as unpredictable weather situations and still be able to continuously operate. The electronics, computers and batteries needed to operate the surveillance devices need to be protected from these conditions at all times, even when the scissor-lift assembly 14 or other elevational mechanism is deployed. Some embodiments of the present invention may be described with reference to FIG. 4. In these embodiments, the base enclosure 10 of the mobile surveillance unit is constructed with appropriate seals and gaskets 42 to provide a weatherproof, dustproof and vandal-proof enclosure for the contents of the base enclosure 10 when the scissor-lift assembly 14 is deployed as well as protecting the surveillance devices 12 when the scissor-lift assembly 14 is retracted and stowed within the base enclosure. In another embodiment of the invention, the portion of the base enclosure 10 used to store electronic components 16 is provided with additional seals or gaskets to protect the electronic components when they are not being used by the operator. Batteries and other equipment (not shown in FIG. 4) may be accessible by means of a separate compartment opening 48 in the base enclosure 10, which may be pulled open for access to the batteries and other equipment. The compartment opening 48 may be lockable, thus enabling authorized access to the equipment in the base enclosure 10 while preventing access or tampering by unauthorized persons.

In some embodiments of the present invention, the surveillance unit can be fitted with Global Positioning System (GPS) equipment 80, which can be housed within the base enclosure 10 for locating the unit in case of theft or unauthorized redeployment or for tracking the location history of the unit for billing or other purposes. In some embodiments the GPS equipment 80 may be a self-contained unit small enough to be concealed practically anywhere within the base enclosure 10 or even on the telescoping mast 20 so as not to be noticeable and to reduce tampering efforts. The GPS equipment 80, when combined with well known software packages and services, may provide detailed reports of location and routes traveled for invoicing, quality-control and security purposes. Additional purposes of the GPS equipment 80 will be described further below.

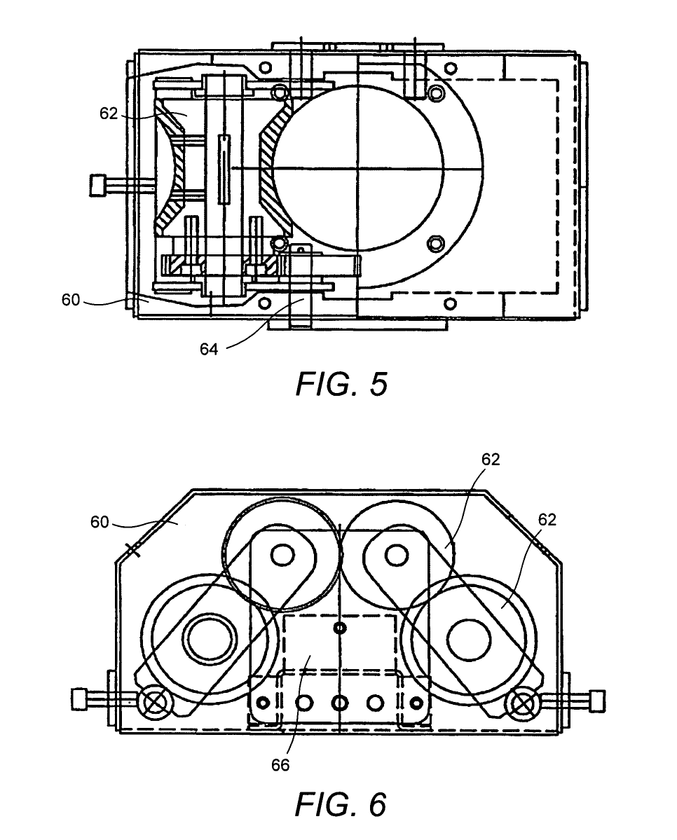

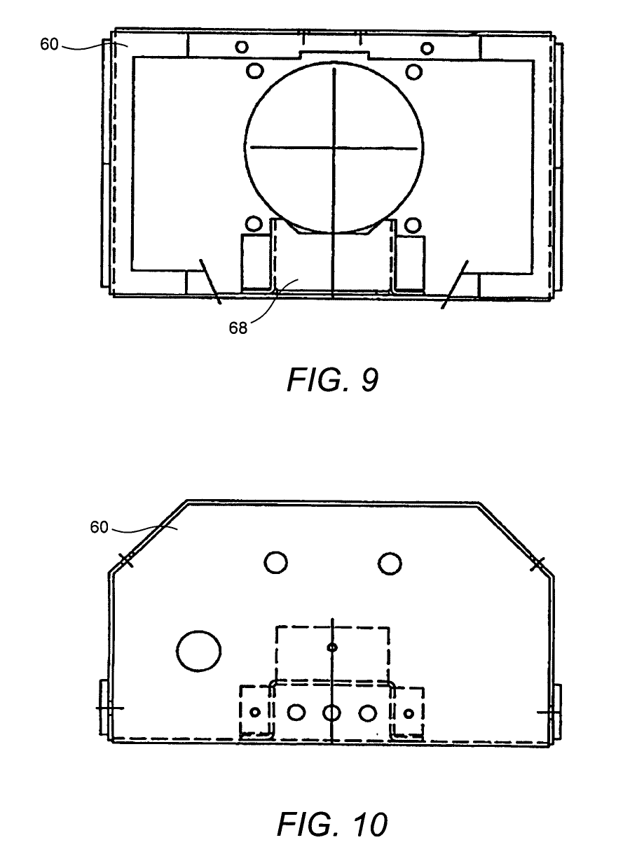

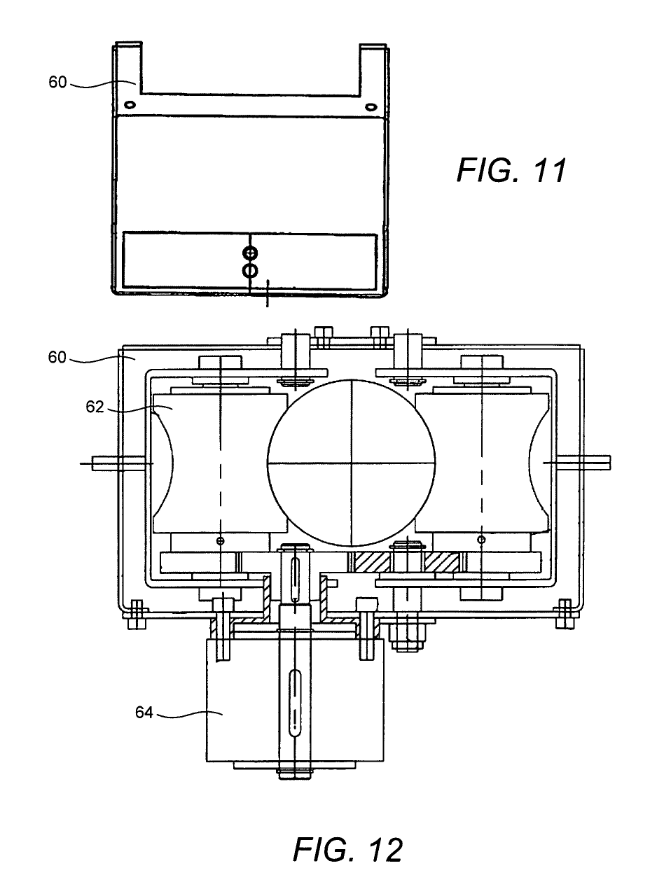

One embodiment of the invention utilizes an alternative mechanism for extending or lowering the telescoping mast 20, namely a gear box 60. One embodiment of a gear box 60 is shown in FIGS. 5-11. The gear box 60 contains various sets of wheels 62. When the wheels 62 of one gear box 60 are spun, the individual segment of the telescoping mast 20 immediately above the gear box 60 is elevated or retracted to alter the height of the surveillance device(s) 12. The wheels may be spun by turning a drive 64 that may be accessible externally to the gear box 60. By way of example, the drive 64 may be turned by attaching a motor to the drive 64. One example of a motor used for turning the drive 64 is a drill motor, such as a cordless drill. The drive 64 may have a keyed receptacle that only receives a particular corresponding keyed drill attachment for security. When the keyed drill attachment is used, the drill (cordless or corded) may then be used to adjust the height of the corresponding segment of the telescoping mast by engaging the drive 64. Without the keyed drill attachment, turning the drive 64 may be difficult or impossible.

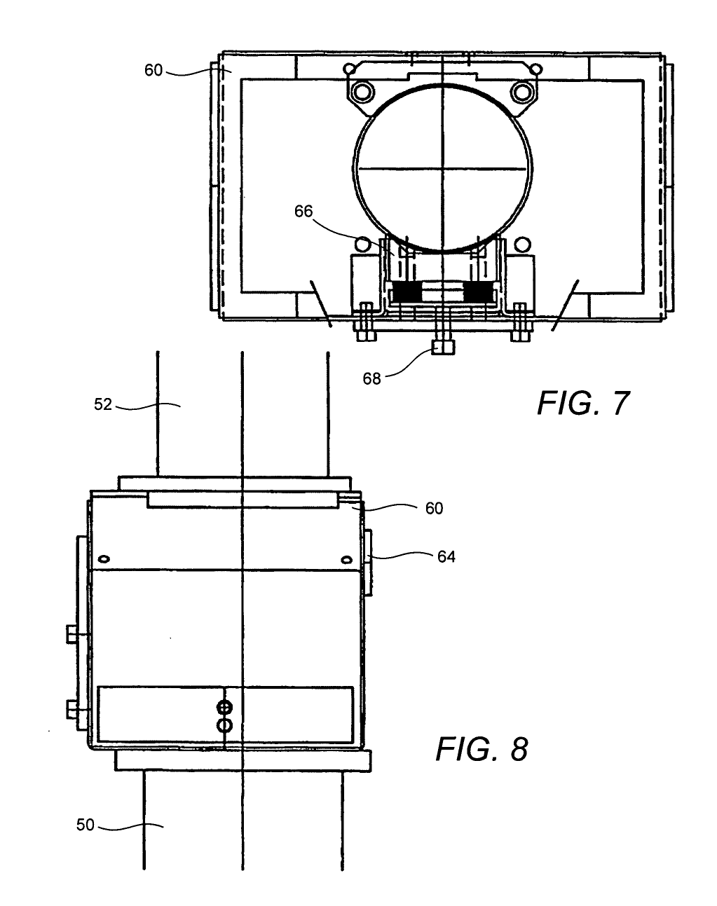

Additionally or alternatively, access to the drive 64 may be physically limited. Access may be physically limited by keeping the lowest gear box 60 within the base enclosure 10, and by having the telescoping action of the gear boxes 60 cause the next lowest gear box 60 elevated out of easy reach of a would-be vandal or criminal. The drive 64 may be connected to the wheels 62 by way of one or more gears, belts, chains, or the like, as will be readily appreciated by one of skill in the art. When extension or retraction of a particular segment of the telescoping mast 20 is not desired, a brake 66 may be activated within or external to the gear box 60 to prevent undesired motion of the segment. Control of the brake 66 may be achieved by way of a brake actuator 68 that is accessible from outside the gear box. As may be appreciated from FIG. 7, the brake 66 may work by clamping the segment of the telescoping mast 20 immediately above the gear box 60.

The particular gear box 60 and wheels 62 that are selected determine the portion of the telescoping mast 20 that is elevated. The telescoping mast 20 may be fully extended in serial fashion by extending the uppermost segment of the telescoping mast 20 first, followed by extending each next lower segment in series until the lowest segment is extended. The telescoping mast 20 can be lowered in reverse order. It should be understood that each segment can be raised or lowered independently as long as the appropriate gear box 60 is selected, reached, and actuated. However, accessing the gear boxes in serial fashion allows each gear box 60 to be accessed from the ground without requiring a user to climb up a ladder or otherwise be elevated. When a lower portion of the telescoping mast is engaged, any gear boxes 60 and segments for the higher portion are elevated with the segment for the engaged gear box 60. Thus, upon retraction, the lowest set of wheels will be engaged and lowered thereby permitting access to the next highest set of wheels which will then be within reach.

FIG. 8 further illustrates how the various segments of the telescoping mast 20 interact at each gear box 60. At each gear box 60, the gear box 60 is fixedly attached atop a lower segment 50 of the telescoping mast 20. The gear box 60 slidingly receives an upper segment 50 of the telescoping mast 20, which frictionally engages the wheels 62. The upper segment 50 also slidingly passes within the lower segment 50 to permit telescoping of the telescoping mast 20. To achieve this, it will be understood that the upper segment 52 has an outer diameter at least slightly smaller than the inner diameter of the lower segment 50. It will be understood that the various segments of the telescoping mast 20 such as lower segment 50 and upper segment 52 are hollow to allow nesting and for other reasons that will be described further below. While FIGS. 5-11 illustrate a telescoping mast 20 with segments having an approximately circular cross-section, those of skill in the art will readily appreciate that other cross-sectional shapes may be used for the segments of the telescoping mast 20. For example, the cross-sectional shape may be oval or ellipsoid, or may have a square, hexagonal, or other polygonal shape. In addition, the segments may also include one or more notches and/or protrusions to maintain a desired rotational orientation of each segment relative to the next.

In some embodiments, the drive 64 with its external attachment point may be replaced by a motor. In such embodiments, the telescoping of the various segments by the gear boxes 60 may be controlled by electronics or other controls either at the base enclosure 10 or remotely. FIG. 12 illustrates an alternate embodiment of the gear box 60, and those of skill in the art may recognize that the embodiments of FIGS. 5-11 and FIG. 12 may be modified to include a motor to drive telescoping action of the telescoping mast 20. In addition, those of skill in the art will also appreciate that other systems may be used to cause telescoping of the telescoping mast 20, such as hydraulic and pneumatic lifts.

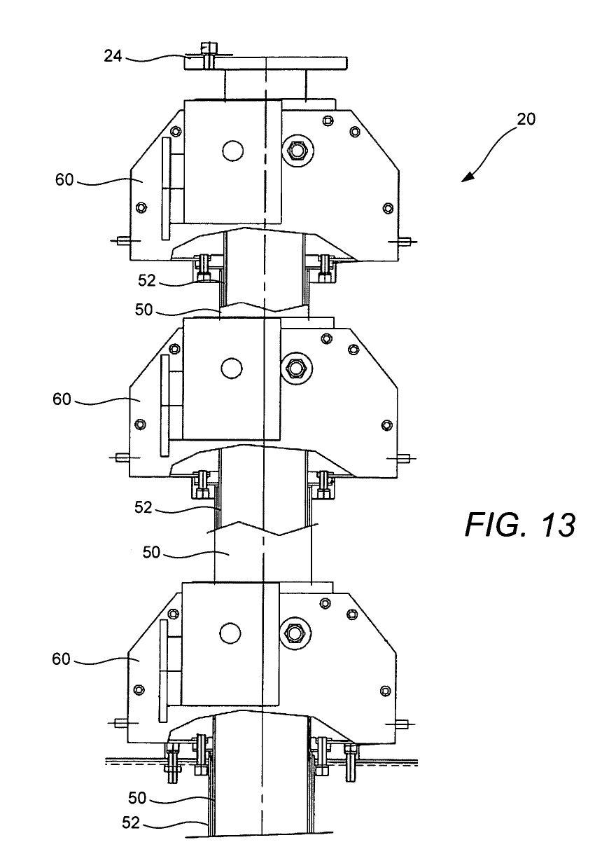

FIG. 13 more clearly illustrates the nesting of the various lower segments 50 and upper segments 52 at the gear boxes 60 to form the telescoping mast 20. As will be appreciated, the segment of the telescoping mast 20 that is the upper segment 52 at one gear box 60 is simultaneously the lower segment 50 at the next higher gear box 60.

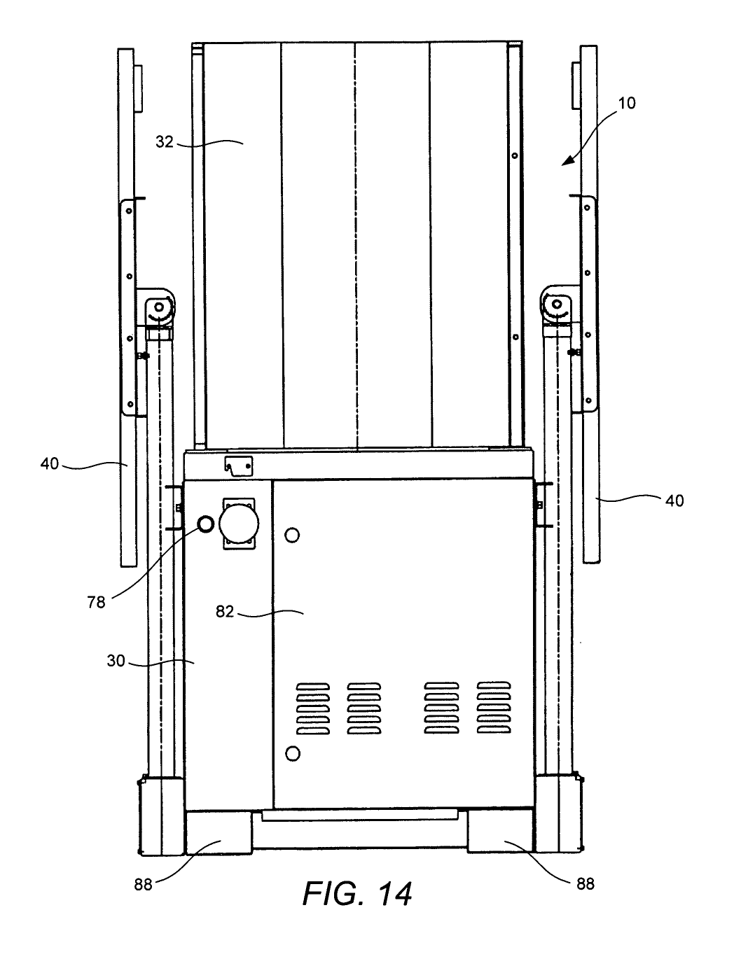

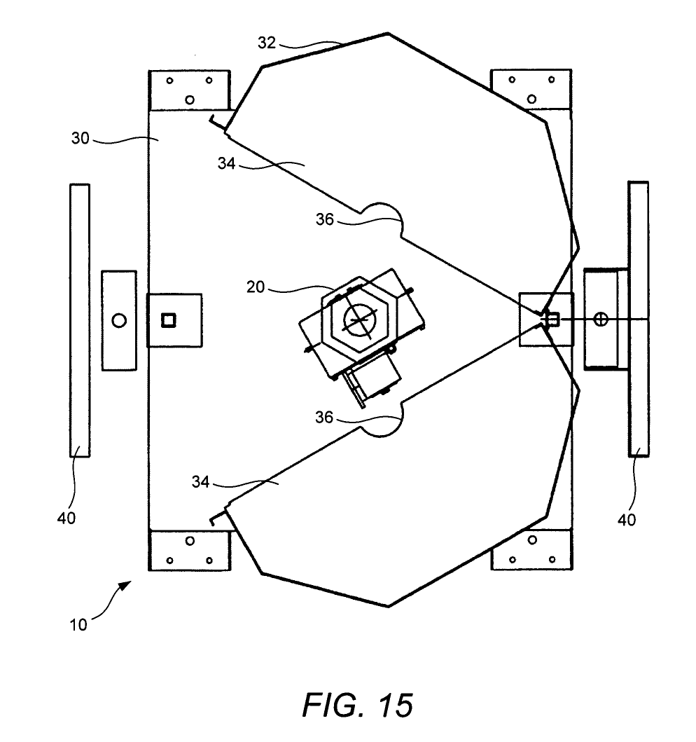

FIGS. 14-17 illustrate an alternate configuration of the base enclosure 10. In this configuration, the base enclosure 10 includes a lower base enclosure 30 and an upper base enclosure 32. In at least some embodiments, as illustrated in FIG. 15, the upper base enclosure 32 may be openable to expose the telescoping mast 20 and to permit the telescoping mast 20 to extend upward with the surveillance device(s) 12 as described above. In some embodiments, the upper base enclosure 32 is openable in that the upper base enclosure 32 includes two halves 34 that split apart to permit access to the interior of the upper base enclosure 32. The upper base enclosure 32 may have a mast opening 36 formed in it, that allows the upper base enclosure 32 to be re-closed with the telescoping mast 20 fully or partially extended, and may be provided with seals or gaskets that engage the fully- or partially-extended telescoping mast 20 to protect any equipment inside the upper base enclosure 32 when it is closed. In other embodiments, no seals or gaskets are needed as all sensitive equipment is contained within the lower base enclosure 30.

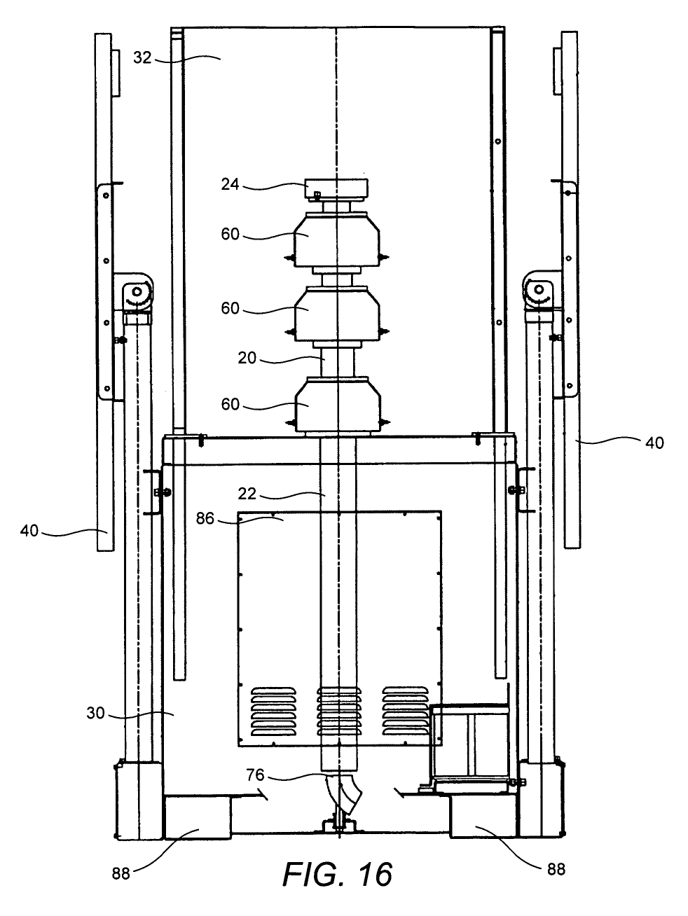

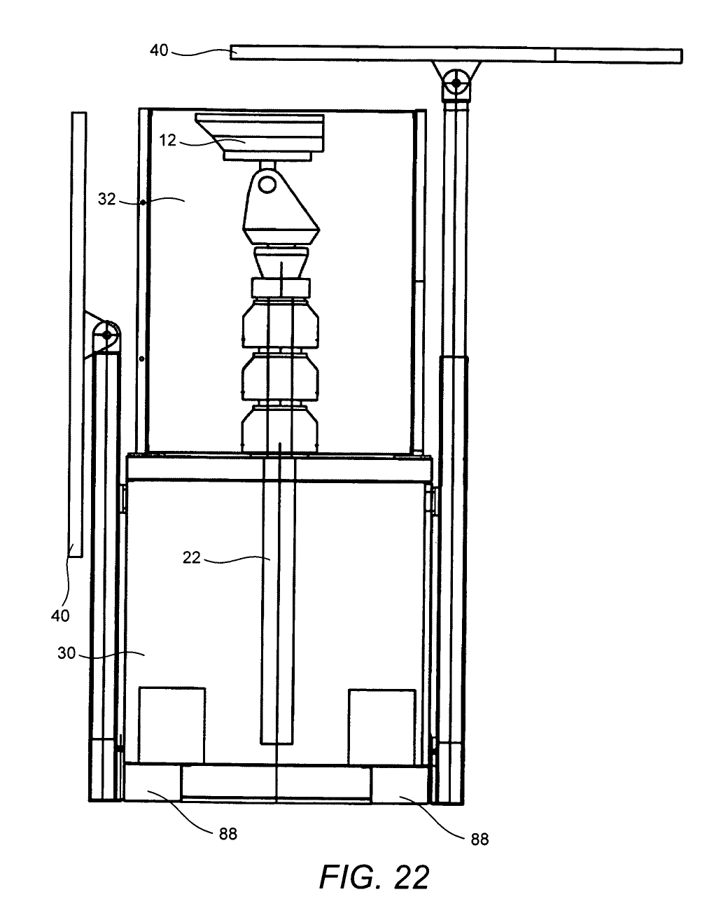

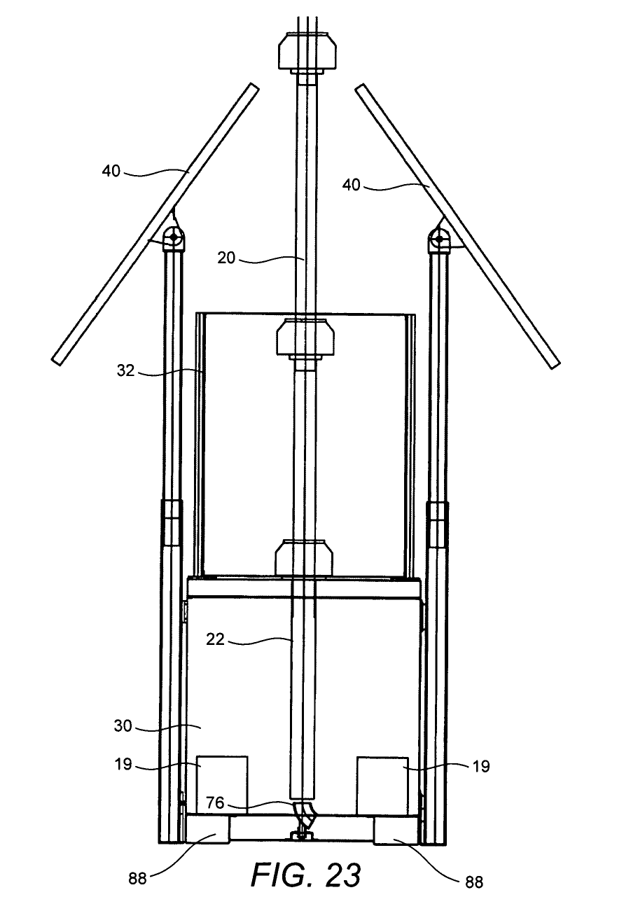

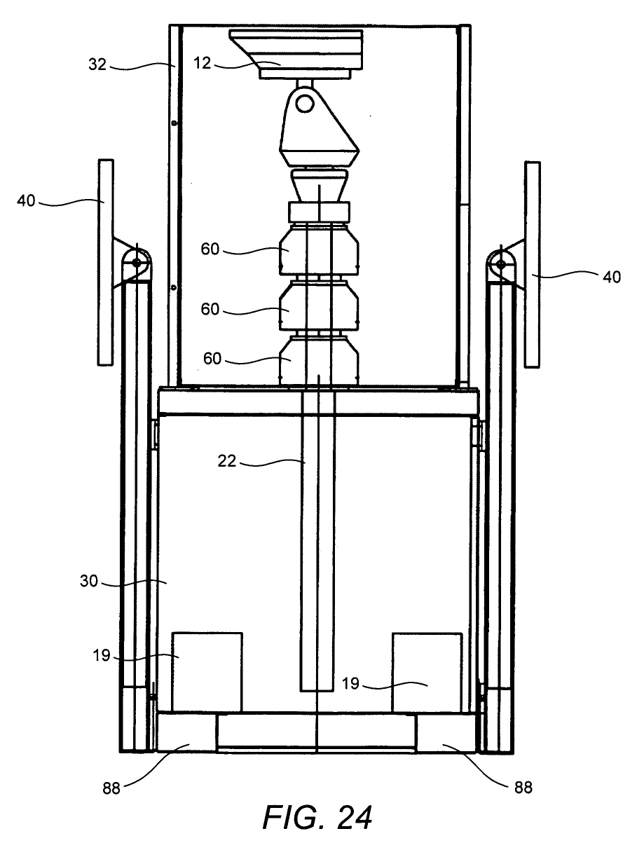

FIG. 16 shows this embodiment in a stored position for transport. In this configuration, the telescoping mast 20 is fully retracted and is fully contained within the upper base enclosure 32 and the lower base enclosure 30. As may be seen from FIG. 16, all three gear boxes 60 are fully contained within the upper base enclosure 32, and additional room is available above the distribution box/platform 24 for the surveillance device(s) 12 attached to the distribution box/platform 24 to also be contained within the upper base enclosure 32, such as during periods of non-use or transport. FIGS. 22 and 24 illustrate how the surveillance device(s) may be stored within the upper base enclosure 32.

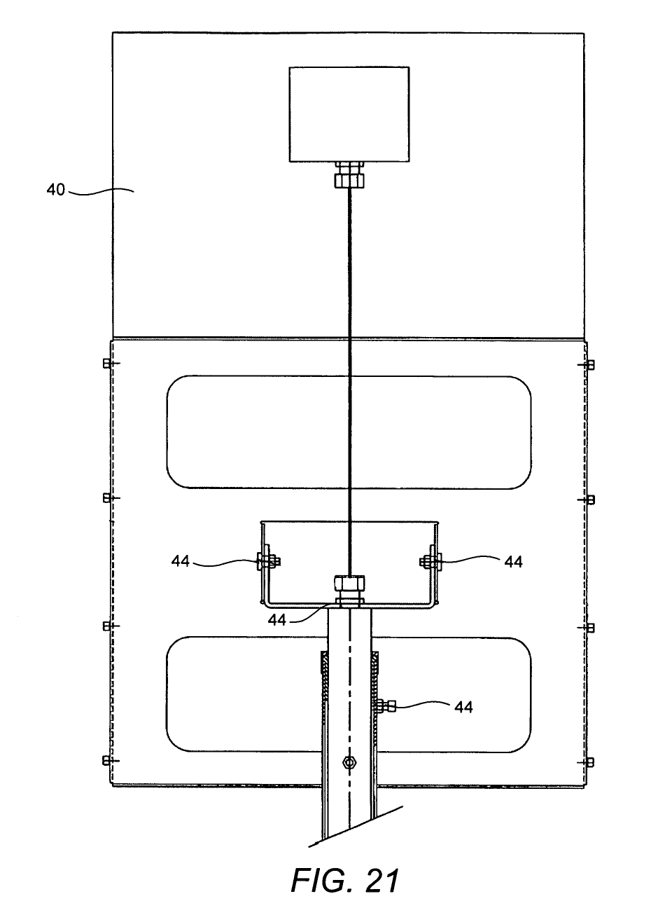

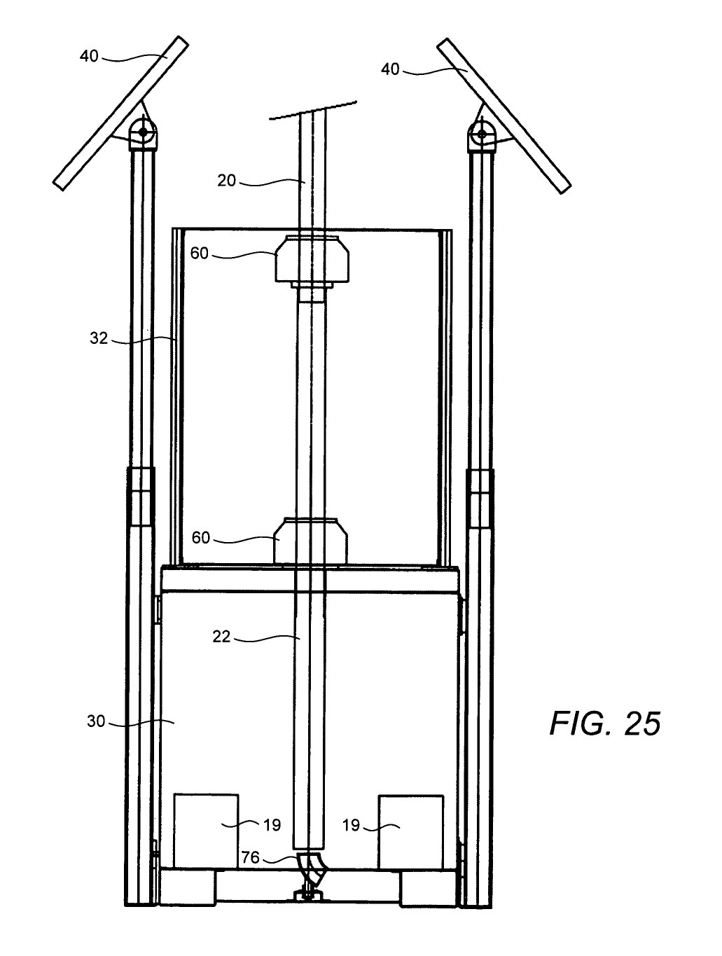

FIGS. 14-17 also show a pair of solar panels 40 that may be mounted to the base enclosure 10 or to some other location of the surveillance unit. The solar panels 40 may provide an additional power source for the surveillance unit, and may allow the surveillance unit to function independently of any hard-wired or plug-in power source. As will be noted from FIGS. 14-16 and 20-25, the solar panels 40 may be of varying sizes and configurations, and may be mounted on telescoping poles and may be mounted so as to be rotatable into various positions to take maximum advantage of the amount of available sunlight. The solar panels 40 may have a stored position such as that illustrated in FIG. 14 when not in use, and may have various operating positions, such as illustrated in FIGS. 22 and 23. FIGS. 20 and 21 show more detailed views of the solar panels 40 and the moveable connections 44 that may be used to mount the solar panels 40 to achieve the flexibility described herein.

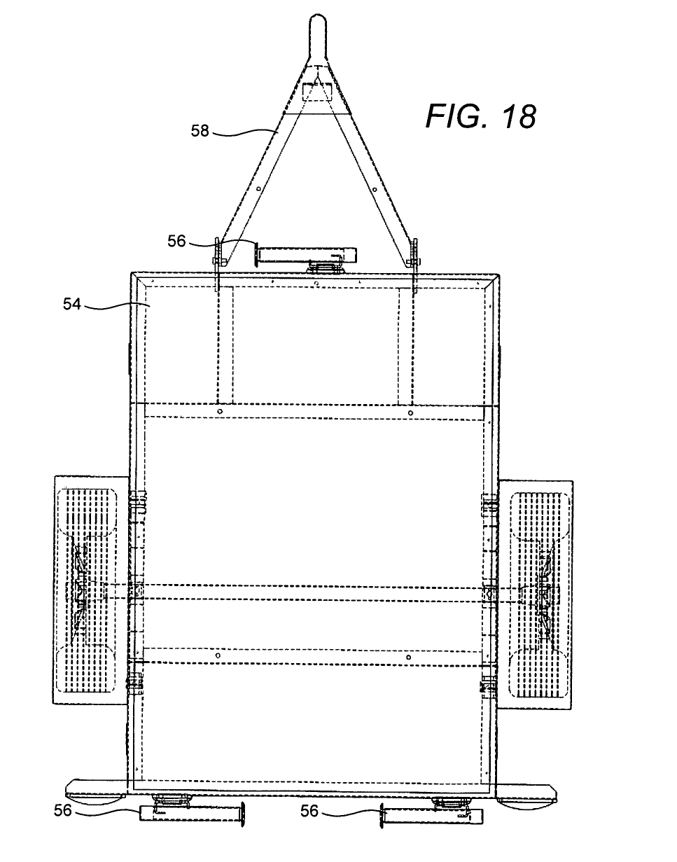

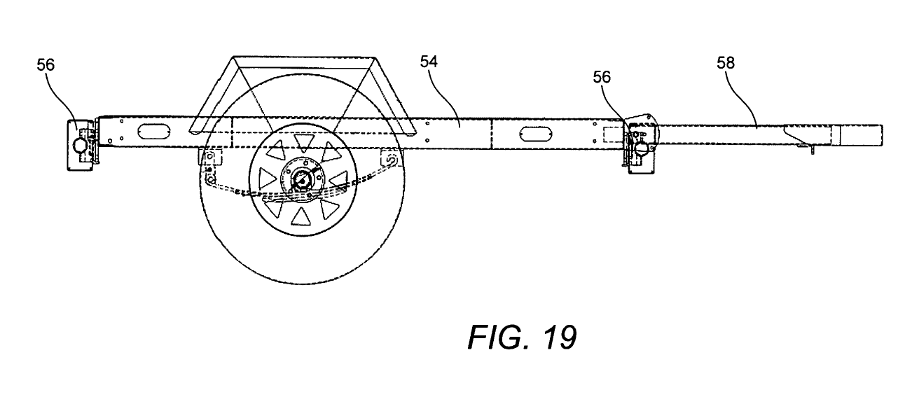

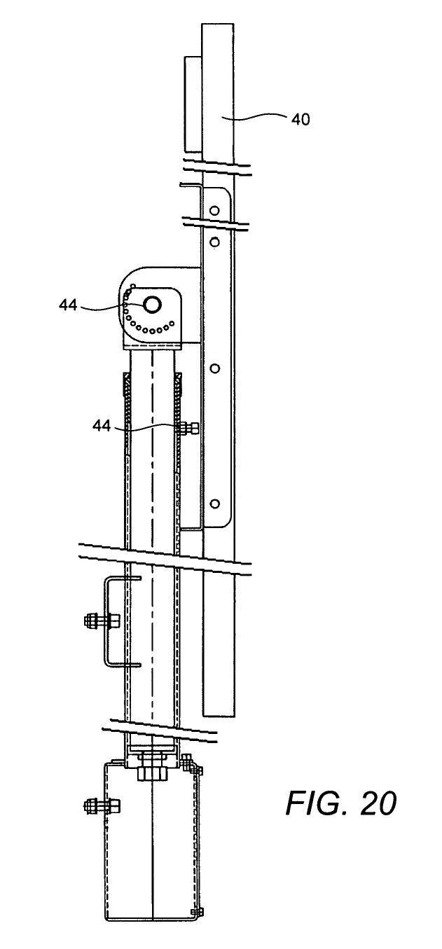

As has been described above, embodiments of the surveillance unit may be mounted on a trailer for ready transport between surveillance locations. FIGS. 18 and 19 illustrate a trailer 54 suitable for use with embodiments of the invention. As has been indicated, the trailer 54 may include a plurality of jacks 56 for stabilizing the trailer 54 during surveillance operations. In addition, for security purposes, a tongue 58 of the trailer 54 may be removable or may rotate to and lock in a non-functional position to prevent would-be thieves, criminals, or vandals from moving or stealing the trailer 54 and surveillance unit.

As previously mentioned, the hollow nature of the telescoping mast 20 provides advantages heretofore unknown in the art of surveillance equipment. Specifically, the power, control, and video cables 15, and any other type of wiring or cabling desired between the surveillance device(s) 12 and the electronics equipment 16 and power supply 18 can be contained wholly within the telescoping mast 20. This provides numerous benefits over existing systems, which typically provide the cabling external to the support, such as a coiled cable around a tower. External cables suffer from various problems. These problems include degradation of the cables' insulation due to ultraviolet (UV) exposure and exposure to the elements. Therefore, internal cables that are not exposed to UV radiation and harsh weather conditions typically last longer. Additional problems with external cables for surveillance systems include the ease with which a vandal or criminal can cut wiring or cabling, thereby effectively disabling the surveillance systems. When the cables 15 are contained entirely within the telescoping mast 20 (at least up to the distribution box/platform 24), they are better protected from vandals/criminals, who find it much more difficult to cut the telescoping mast 20 than it would be to merely cut external cables. As the telescoping mast 20 may be made from any of a number of durable, weather-resistant materials, such as stainless steel, aluminum, or even plastics, most persons desiring to sabotage the surveillance unit will find it difficult to quickly cut and sabotage the telescoping mast 20.

While placing the cables 15 inside the hollow telescoping mast 20 provides certain benefits, this location for the cables 15 also provides certain challenges that must be addressed. Specifically, as the telescoping mast 20 is extended or retracted, the cables 15 move within the telescoping mast, and are subject to several problems, including abrasion of the cables 15 on the insides of the various sections of the telescoping mast 20 and bunching or knotting of the cables 15 during repeated extension and retraction of the telescoping mast 20.

To alleviate these problems, embodiments of the invention utilize several unique features. First, to reduce abrasion and make sure that the cables 15 are able to easily slide within the sections of the telescoping mast 20, the cables 15 may be encased within a woven nylon harness. The nylon harness may be woven in a fashion similar to the weaving used for the popular so-called Chinese finger cuffs. When the nylon harness is longitudinally compressed, its diameter expands, and the wires may be easily passed through the harness. When the harness is longitudinally decompressed or expanded, its diameter contracts and tightens up around the wires. It is anticipated that any suitable material may be used for the harness. Nylon has been found to work well for the harness because it is tough and resistant to abrasion and because it is slick with a low coefficient of friction that allows it to slide easily during movement of the telescoping mast 20. In some embodiments, a washer-fluid tube may also be included with the cables 15 in the harness to supply washer fluid to the surveillance device(s) 12 to keep the surveillance device(s) 12 clean.

The harness addresses the issue of abrasion and friction. Embodiments of the invention utilize an additional feature to properly spool and wind (and unspool/unwind) the harness-encased cables 15 within the base enclosure 10 and specifically the lower base enclosure 32 in embodiments having the lower base enclosure 32. This additional feature is a rotating elbow 76, as depicted in FIGS. 1, 3, 16, 23, and 25. The rotating elbow 76 has a substantially-vertical axis of rotation, and is provided at the bottom of the lower portion 22 of the telescoping mast 20. It receives the cables 15 within the harness and the remainder of the cables 15 within the harness that is not required to reach within the telescoping mast 20 is coiled around the lower periphery of the base enclosure 10 (i.e. the lower periphery of the lower base enclosure 30 in FIGS. 16, 23, and 25). As the telescoping mast 20 is extended upward, an additional length of the cables 15 are drawn into the telescoping mast 20 through the rotating elbow 76, which rotates to accept the cables 15 during this operation. Then, as the telescoping mast 20 is retracted downward, an additional length of the cables 15 pass out from the telescoping mast 20 through the rotating elbow 76, and are re-coiled around the periphery of the base enclosure 10 automatically as the rotating elbow rotates 76. In this way, the rotating elbow 76 works both to reduce the possibility of abrasion and to assist in winding and unwinding the cables 15 as they are deployed and retrieved during telescoping mast 20 operations.

The electronics equipment 16 connected to the surveillance device(s) 12 through the cables 15 so deployed may be used for a variety of functions. As described above, the electronics equipment 16 may be utilized to automatically and/or manually control functions of the surveillance device(s) 12. Additionally, the electronics equipment 16 may also be used to enable remote-based automatic and/or manual control of such functions. In some embodiments, a portion of the electronics equipment 16 may be located in or provided with the surveillance device(s) 12 at the top of the telescoping mast 20. As set forth above, the surveillance device 12 may include a camera, including an advanced closed circuit television camera, such as those manufactured by Pelco, Inc. of Clovis, Calif. By way of example, a Pelco® model ES31PCBW24-2N Pedestal Mount camera may be used.

The electronics equipment 16 may include encoders, video motion detectors, and other devices such as those manufactured by Bosch Security Systems of Fairport, N.Y. By way of example only, a Bosch® VIP X1 single-channel video encoder may be utilized with embodiments of the present invention. Such devices may include on-board video motion detection and other features that enhance the security possibilities that may be used with surveillance units, as will be described hereafter. The electronics equipment 16, taken together, can perform a wide variety of power and surveillance functions. By way of example, the power supply 18 may include one or a plurality of batteries 19, as described above. In some embodiments, the solar panel(s) 40 may not be capable of simultaneously charging all available batteries 19. In addition, the functions of the electronics equipment 16 may not require simultaneous use of all available batteries 19. Therefore, in some embodiments, the electronics equipment 16 may intelligently control the use of one or more of the batteries 19 for surveillance purposes and may also intelligently control the charging of one or more of the batteries 19 in groups or individually within the capability of the solar panel(s) 40. Such control may also maximize the life of the batteries 19.

As another example, the electronics equipment 16 may include video storage capabilities (i.e. a digital video recorder (DVR) or an integrated hard drive to perform many of the same functions performed by conventional DVRs) and may intelligently determine what video to store and when, whereby the video storage capability is not overwhelmed by irrelevant video or other surveillance data. The electronics equipment 16 may evaluate surveillance and/or video information and may intelligently determine to provide an alert to a remote monitoring station, via e-mail, or by telephone as the surveillance and/or video information is being obtained, so that any necessary response may be undertaken immediately. In this way, a crime may be detected and stopped rather than merely recorded and subsequently prosecuted. Similarly, the electronics equipment 16 may evaluate surveillance and/or video information and may selectively record all or a portion of this information to maximize data storage space during surveillance. As may be appreciated by those of skill in the art, the electronics equipment 16 may be programmed to perform a wide variety of functions of the type described above. Other functions that may be achieved by the electronics equipment include facial recognition, voice- or other-sound-activated alarms, long-range communications such as by cellular or satellite communications, etc.

When such functions are combined with the portability, flexibility, and independent operability that is provided by the embodiments of the invention as described above, a number of functions become available that have not previously been available. By way of example, a job site in a location lacking power or other hard-wired connections typically necessary for existing surveillance equipment may easily be monitored by one or more surveillance units as described herein. As set forth above, the surveillance units may easily be moved within a job site, as necessary, such as during construction, to suit changing surveillance needs. In addition, as set forth above, alerts of suspicious or unwanted activity may be provided immediately upon occurrence, and crimes may be stopped instead of merely prosecuted. Thus, surveillance units as described herein promise significant installation savings as well as significant savings in stopping crimes and other costly events.

As another example, a surveillance unit as described herein may be provided with an alert or alarm button 78, and may be placed in a location where an alarm or alert communication unit is needed. One example of such a location is on a mountain peak or remote trail, on a commonly-traveled outdoor walkway of a university campus, in a parking lot, etc. In such situations, the surveillance unit may remain essentially inactive until activated by the alert or alarm button 78. Alternatively, the surveillance unit may perform its functions as normal. Upon activation of the alert or alarm button 78, the surveillance unit may automatically direct its camera or other surveillance device 12 to the location of the alert or alarm button 78, and may establish communication with a remote monitoring location (such as by satellite or cellular communication, or by some other wireless communication system). A person in the remote monitoring location may be provided with the video feed, may control the camera or other surveillance device 12, and may be able to communicate with the person activating the alert or alarm button 78 and with others in the area. This may be useful in the event a hiker is injured, or in the event that a person on the university campus or in the parking lot is molested, robbed, or otherwise attacked, and may act as a deterrence for attackers. As embodiments of the surveillance units are provided with solar power and are capable of operating indefinitely without being connected to any hard-wired power grid, the units are very flexible in the manner in which they can be utilized.

Additional features of embodiments of the invention may be appreciated by reference to FIGS. 14-17. These Figures illustrate various views of an embodiment of the invention, and illustrate how various embodiments provide for a highly-secure, highly-transportable, compact and self-contained surveillance unit. Specifically, existing mobile surveillance systems are typically not compact and are not secure against tampering, etc. Additionally, existing mobile surveillance systems do not adequately protect the surveillance devices from damage during transport or require removing the surveillance devices during transport. Embodiments of the invention solve these problems and provide a compact, completely self-contained mobile surveillance system that is secured against tampering, etc.

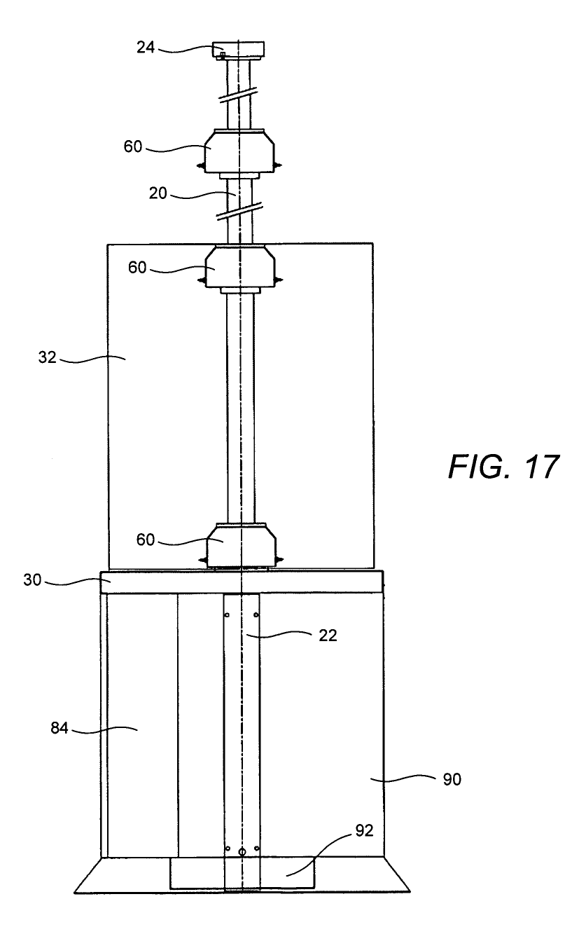

Specifically, FIG. 14 illustrates what may be considered a front perspective view of an exemplary surveillance system, FIG. 15 illustrates a top perspective view of the same, FIG. 16 illustrates a back plan view of the system, and FIG. 17 illustrates a side partial plan view of the system. In FIG. 14, an electronics compartment cover 82 is shown, and the electronics compartment cover 82 provides access to an electronics compartment 84. As may be seen in FIG. 17, the electronics compartment 84 is a narrow compartment disposed along one side of the lower base enclosure 30, and may have a compartment depth of approximately 20%-40% of the total depth of the lower base enclosure 30. The compartment depth may be varied as needed to substantially enclose the electronics equipment 16 for the surveillance system. The width and height of the electronics compartment 84 may be varied as needed within the overall dimensions of the lower base enclosure 30, but may substantially match the size of the electronics compartment cover 82, as depicted in FIG. 14. In at least some embodiments, the electronics compartment 84 may be manufactured of a high-strength material or may be reinforced so as to better prevent disruption of the tasks performed by the electronics equipment 16.

As may be appreciated, a substantially free-standing surveillance unit, such as depicted, may utilize a number of batteries such as batteries 19. By way of example, four batteries 19 may be included in a battery/main compartment 90 that is accessible by way of a battery/main compartment cover 86. One embodiment of the battery/main compartment cover 86 is depicted in FIG. 16. The battery/main compartment 90 may include the portion of the lower base enclosure 30 not taken up by the electronics compartment 84, and may include the lower portion 22 of the telescoping mast 20. In addition, the battery/main compartment 90 may include a coiled cable portion 92 that receives the cables 15 contained in the harness, as spooled by the rotating elbow 76. In some embodiments, the coiled cable portion 92 may be disposed between the lift rings/forklift slots 88.

As is well known, many batteries rely on various chemicals and acids to function/store energy. As is also known, many types of electronics equipment are less than ideally compatible with such chemicals and acids. Therefore, it is generally desirable to keep most electronic equipment separate from the power-supplying batteries. Because of this, the electronics compartment 84 is provided separately from the battery/main compartment. This is a type of physical separation. To provide further protection for the electronics equipment 16, embodiments of the invention directionally control the flow of cooling air for the surveillance system. Specifically, cooling air may be directionally provided so as to minimize the exposure of any leaking acids/chemicals from the batteries 19 that would otherwise be exposed to the electronics equipment 16. One or more fans may be provided that draw external air through vents in the electronics compartment cover 82, into the electronics compartment 84 to cool the electronics equipment 16. The fan(s) may then draw the air into the battery/main compartment 90 and may push the air out of vents in the battery/main compartment 90 or in the battery/main compartment cover 86. This uni-directional air flow better protects the electronics equipment 16 from unwanted potential exposure to battery acids/chemicals.

As depicted in FIGS. 15 and 16, and as discussed above, the upper base enclosure 32 provides a secure and protected location for any attached surveillance device(s) 12 during transport and storage of the surveillance unit. Because of the compact nature of the fully-assembled surveillance system, the system may be transported by trailer or in any other way, may be easily deployed on location, and may be re-deployed as necessary or desired, without requiring disassembly of the attached surveillance device(s) 12 and without concern that thieves, vandals, etc. might try to disable the surveillance system by interfering with the equipment or severing connections between the various components of the system.

Thus, embodiments of the present invention provide an improvement in job site security and surveillance and other forms of surveillance, preventing theft, vandalism, and other harmful activities. Video surveillance reduces the number of security guards needed to cover large or remote areas while ensuring continuous monitoring of all areas of the jobsite. A mobile surveillance unit with a telescoping mast eliminates the cost of installing poles, trenching and pulling cable for cameras. The system can be fully operational in a fraction of the time required for permanently mounted surveillance camera systems with much lower installation costs. A mobile surveillance unit allows the property owner to instantly set up temporary surveillance networks for special events, shipping yards, and construction sites, and quickly remove them when no longer needed.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A surveillance system comprising:
a substantially-enclosed and secure lower base enclosure comprising:
an electronics compartment; and
a main compartment physically separated from the electronics compartment;
an upper base enclosure that is openable and that is attached to the lower base enclosure; and
a telescoping mast, wherein a lower portion of the telescoping mast is disposed inside the lower base enclosure, and wherein when the telescoping mast is in a fully-lowered position, the entire telescoping mast is contained within the lower base enclosure and the upper base enclosure, whereby any surveillance devices attached at the top of the telescoping mast are situated within the upper base enclosure when the upper base enclosure is in a closed position.

2. The surveillance system of claim 1, further comprising a surveillance device attached at the top of the telescoping mast.

3. The surveillance system of claim 1, wherein the lower portion of the telescoping mast is contained within the main compartment of the lower base enclosure.

4. The surveillance system of claim 1, wherein the telescoping mast comprises:
a plurality of hollow nesting mast segments, wherein the mast segments are configured to be slidingly received within one another to form the mast, wherein the plurality of mast segments comprises:
an innermost and uppermost mast segment having a smallest diameter; and
an outermost and lowest mast segment having a largest diameter;
a plurality of gear boxes wherein each gear box is fixedly attached to the top of one of the plurality of mast segments not the innermost and uppermost mast segment, and wherein each gear box comprises:
wheels configured to frictionally engage the next inner and upper mast segment, whereby when the wheels are turned in a first direction, the next inner and upper mast segment is driven upward and whereby when the wheels are turned in a second direction opposite to the first direction, the next inner and upper mast segment is driven downward; and
a drive configured to drive turning of the wheels.

5. The surveillance system of claim 1, wherein the telescoping mast comprises:
a plurality of hollow nesting mast segments, wherein the mast segments are configured to be slidingly received within one another to form the mast;
a plurality of pivotally-moveable support brackets attached to the mast segments;
a threaded shaft connected to at least one of the plurality of pivotally-moveable support brackets; and
a motor attached to the threaded shaft to drive rotation of the threaded shaft, whereby rotation of the threaded shaft causes scissoring of the plurality of pivotally-moveable support brackets and a corresponding telescoping of the telescoping mast.

6. The surveillance system of claim 1, wherein cables contained in a harness are disposed within the telescoping mast.

7. The surveillance system of claim 6, wherein the telescoping mast further comprises a rotating elbow disposed within the lower base enclosure at a lower end of the lower portion of the telescoping mast, wherein the rotating elbow spools and despools the cables within a portion of the lower base enclosure during telescoping of the telescoping mast.

8. The surveillance system of claim 1, wherein the lower base enclosure contains a plurality of batteries to power the surveillance system.

9. The surveillance system of claim 8, further comprising solar panels for recharging the batteries.

10. The surveillance system of claim 9, wherein the electronics equipment is configured to intelligently control use of and recharging of the batteries.

11. The surveillance system of claim 1, further comprising:
a global positioning system (GPS) device; and
a wireless communications device.

12. The surveillance system of claim 11, further comprising an alert button on the lower base enclosure.

13. A telescoping mast comprising:
a plurality of hollow nesting mast segments, wherein the mast segments are configured to be slidingly received within one another to form the mast, wherein the plurality of mast segments comprises:
an innermost and uppermost mast segment having a smallest diameter; and
an outermost and lowest mast segment having a largest diameter;
a plurality of gear boxes wherein each gear box is fixedly attached to the top of one of the plurality of mast segments not the innermost and uppermost mast segment, and wherein each gear box comprises:
wheels configured to frictionally engage the next inner and upper mast segment, whereby when the wheels are turned in a first direction, the next inner and upper mast segment is driven upward and whereby when the wheels are turned in a second direction opposite to the first direction, the next inner and upper mast segment is driven downward; and
a drive configured to drive turning of the wheels.

14. The telescoping mast of claim 13, further comprising a distribution box and platform attached at the top of the telescoping mast.

15. The telescoping mast of claim 14, further comprising a surveillance device attached at the top of the telescoping mast.

16. The telescoping mast of claim 13, further comprising a surveillance device attached at the top of the telescoping mast.

17. The telescoping mast of claim 13, wherein the telescoping mast is contained within a mobile surveillance unit comprising:
a substantially-enclosed and secure lower base enclosure comprising:
an electronics compartment; and
a main compartment physically separated from the electronics compartment; and
an upper base enclosure that is openable and that is attached to the lower base enclosure;
whereby a lower portion of the telescoping mast is disposed inside the lower base enclosure, and wherein when the telescoping mast is in a fully-lowered position, the entire telescoping mast is contained within the lower base enclosure and the upper base enclosure, whereby any surveillance devices attached at the top of the telescoping mast are situated within the upper base enclosure when the upper base enclosure is in a closed position.

18. The telescoping mast of claim 13, further comprising cables to support an electronic surveillance device at the top of the telescoping mast, wherein the cables are disposed within the hollow mast segments.

19. The telescoping mast of claim 18, wherein the cables are contained in a harness that reduces abrasion on the cables by the telescoping mast.

20. The telescoping mast of claim 18, further comprising a rotating elbow disposed at the bottom of the telescoping mast that automatically spools and unspools the cables as the mast is telescoped in and out, respectively.
